(19) United States
(12) Patent Application Publication
(10) Pub. No.: US 2025/0200735 A1
(43) Pub. Date: Jun. 19, 2025

(54) VIDEO QUALITY EVALUATION BASED ON TRAINED NEURAL NETWORKS

(71) Applicant: Intel Corporation, Santa Clara, CA (US)

(72) Inventors: Akshay Jindal, Redmond, WA (US); Nabil Sadaka, Portland, OR (US); Manu Mathew Thomas, Fremont, CA (US); Anton Sochenov, Redmond, WA (US)

(73) Assignee: Intel Corporation, Santa Clara, CA (US)

(21) Appl. No.: 19/065,735

(22) Filed: Feb. 27, 2025

(51) Int. Cl. G06T 7/00; G06N 3/08; G06V 10/82; G06V 20/40

(52) U.S. Cl. CPC G06T 7/0002; G06N 3/08; G06V 10/82; G06V 20/46; G06T 2207/10016; G06T 2207/20084; G06T 2207/30168

(57) ABSTRACT

Systems, apparatus, articles of manufacture, and methods to evaluate video quality based on trained neural networks are disclosed. An example apparatus disclosed herein obtains, using a trained neural network, target features corresponding to a target video, the target features based on one or more layers of the trained neural network. The example apparatus also obtains, using the trained neural network, reference features corresponding to a reference video, the reference features based on the one or more layers of the trained neural network, the reference video associated with the target video. The example apparatus further outputs a quality metric for the target video based on the target features, the reference features, and a set of weights. In some examples, the apparatus optionally outputs an error map for the target video.

### BACKGROUND

Video quality evaluation, also referred to as video quality assessment, has a wide variety of applications. Some video quality evaluation applications involve determining video quality metrics to improve (e.g., optimize) compression algorithms, streaming protocols, rendering techniques, etc., to ensure viewers experience acceptable quality under varying network conditions and device constraints. Some existing approaches to assess video quality rely on subjective human evaluations, which, although accurate, are time-consuming, costly, and difficult to scale. Other automated approaches determine objective video quality metrics that attempt to quantify the difference between a target (e.g., distorted) video and a corresponding reference (e.g., undistorted) video. However, such objective video quality metrics may be limited to quantifying a particular type of distortion, such as compression artifacts and transmission errors, but may fail to accurately quantify video quality in the context of more complex distortions introduced by modern video processing and synthetic data generation techniques.

### BRIEF DESCRIPTION OF THE DRAWINGS

FIG. 1 is a block diagram of an example video processing system that includes example neural network video quality evaluation circuitry to evaluate video quality based on a trained neural network in accordance with teachings of this disclosure.

FIG. 2 is a block diagram of an example implementation of the neural network video quality evaluation circuitry of FIG. 1.

FIG. 3 is a block diagram of an example weight learning system to learn weights to be used by the neural network video quality evaluation circuitry of FIGS. 1 and/or 2.

FIGS. 4-5 are flowcharts representative of example machine-readable instructions and/or example operations that may be executed, instantiated, and/or performed by example programmable circuitry to implement the neural network video quality evaluation circuitry of FIGS. 1 and/or 2.

FIG. 6 is a flowcharts representative of example machine-readable instructions and/or example operations that may be executed, instantiated, and/or performed by example programmable circuitry to implement the weight learning system of FIG. 3.

FIG. 7 is a block diagram of an example processing platform including programmable circuitry structured to execute, instantiate, and/or perform the example machine-readable instructions and/or perform the example operations of FIGS. 4-6 to implement the video processing system 100 and/or the weight learning system 300 of FIGS. 1-3.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine-readable instructions of FIGS. 4-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Example systems, apparatus, methods and articles of manufacture (e.g., computer-readable storage media) that implement techniques to evaluate video quality based on trained neural networks are disclosed herein. Videos generated by modern real-time rendering methods may contain annoying spatiotemporal distortions that degrade the visual quality of the video. The distortions can have many forms, such as flicker, noise, blur, aliasing, etc. Furthermore, advanced graphics techniques, such as neural super-sampling, path tracing, novel-view synthesis, variable rate shading, modern photogrammetry, style transfer, etc., have introduced new types of artifacts, exhibiting complex spatiotemporal patterns. Moreover, real-time computer-generated graphics content may present unique visual characteristics that differ substantially from natural videos, further complicating quality assessment. Existing video quality metrics may be unable to quantify the quality of a target video across such combinations of distortions and artifacts in a manner that accurately reflects how a human actually perceives the quality of the video. However, the ability to generate video quality metrics that accurately quantify human perception of video quality can enable modern compression algorithms, streaming protocols, rendering techniques, etc., to be better adapted to ensure viewers experience acceptable quality under varying network conditions and device constraints.

Example video quality evaluation techniques disclosed herein utilize trained (also referred to as pre-trained) neural networks to determine quality metrics for target videos that reflect human perceptual visual quality. Some example quality evaluation techniques also output error maps that highlight areas of target video that exhibit human perceptual distortions. Such a perceptual quality metric has many applications, such as reducing expensive and time-consuming human work associated with subjective assessment in product quality control, reducing computational cost via adaptively allocating rendering budget, achieving higher compression rates while retaining visual fidelity, tuning model hyperparameters, etc.

Example neural network video quality evaluation techniques disclosed herein can also be used to determine video quality metrics that quantify distortions associated with synthetic graphics-produced visuals. For example, video sequences can exhibit distortions caused by popular rendering techniques, such as neural super-sampling, novel-view synthesis, path tracing, neural denoising, frame interpolation, variable rate shading, etc. Examples of the resulting distortions include spatiotemporal aliasing, flicker, ghosting, moire, fireflies, noise, blur, tiling, hallucinations associated with neural reconstruction errors, etc. Disclosed example neural network video quality evaluation techniques can generate per-pixel error maps and/or global video quality scores, which are suitable for computer graphics applications. As such, example neural network video quality evaluation techniques disclosed herein can extend the applicability video quality assessment to emerging areas such as robotics simulation, autonomous vehicles, gaming, streaming, training of foundational visual and multimodal models, novel view synthesis, etc.

As disclosed in further detail below, example neural network video quality evaluation techniques determine video quality based on neural networks, such as three-dimensional (3D) convolutional neural networks (CNNs), that are already trained (also referred to as pre-trained) to perform one or more auxiliary tasks, such as video analytics tasks, other than video quality evaluation. For example, the 3D CNNs used for video quality evaluation may be pre-trained to perform video analytics tasks such as action recognition, video classification, etc. Furthermore, such 3D CNNs can have any appropriate architecture, such as a CNN that performs 3D convolutions at its one or more layers (e.g., an R3D CNN), a CNN that performs a two-dimensional (2D) convolution followed by a one-dimensional (1D) convolutional at its one or more layers (e.g., an R(2+1)D CNN), a CNN that performs mixed convolution, such as 2D convolution at some layers and 3D convolution at other layers (e.g., an M3D CNN), etc.

As disclosed in further detail below, example neural network video quality evaluation techniques process a target (e.g., distorted) video and a reference video (e.g., which corresponds to the target video) with a trained neural network (e.g., a trained 3D CNN) to obtain target features and reference features from one or more layers of the trained neural network. For example, the target features can correspond to the activations produced at one or more layers of the trained neural network when processing the target video, and the reference features can correspond to the activations produced at those same one or more layers of the trained neural network when processing the reference video. Example neural network video quality evaluation techniques then determine a video quality metric based on the target features, the reference features and a set of weights that are learned to combine the target features and the reference features to output a video quality metric representative of human-perceived quality of the target video. Some example neural network video quality evaluation techniques additionally or alternatively output an error map based on the target features, the reference features and the set of weights that indicates areas of the video associated with detectable quality degradation.

Conceptually, the features (e.g., activations) extracted from the layer(s) of the neural network and used to generate the video quality metric and/or error map for the target video are proxies for the assessments made by the human brain when perceiving the target and reference videos. As such, the combining of such features using appropriately learned (or calibrated) weights can yield a video quality metric and an error map that can accurately mimic human perception of the target video, including the overall quality and area(s) associated with detectable degradation. Moreover, the neural network video quality evaluation techniques disclosed herein can be fully automated and deployed in the field to provide feedback (e.g., the video quality metric, the error map, etc.) to adjust video processing algorithms (e.g. compression algorithms, streaming protocols, rendering techniques, etc.) to achieve an acceptable viewer experience.

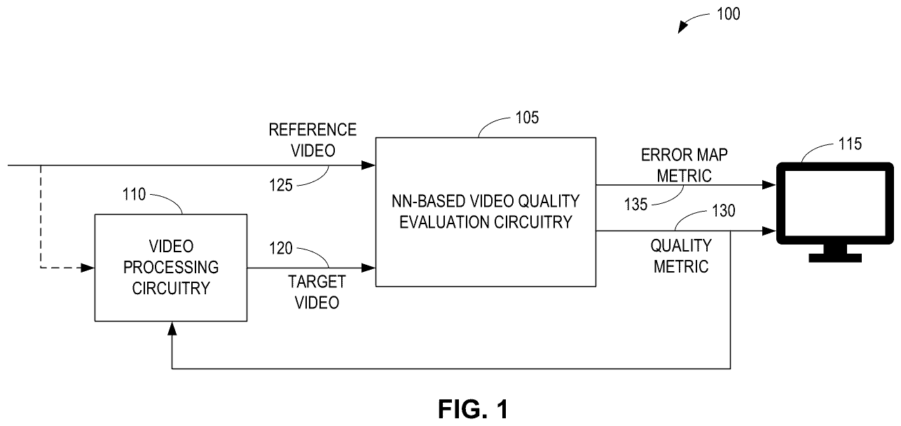

Turning to the figures, FIG. 1 is a block diagram of an example video processing system 100 that includes example neural network (NN) video quality evaluation circuitry 105 to evaluate video quality based on a trained neural network in accordance with teachings of this disclosure. The video processing system 100 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the video processing system 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example video processing system 100 of FIG. 1 includes the NN-based video quality evaluation circuitry 105, example video processing circuitry 110, and an example display device 115. The NN-based video quality evaluation circuitry 105 of the illustrated example includes an input to accept an example target video 120 for which video quality evaluation is to be performed. The NN-based video quality evaluation circuitry 105 also includes an input to accept an example reference video 125 associated with the target video 120. In some examples, the target video 120 is a degraded version of the reference video 125, such as in scenarios in which the target video 120 is generated by performing one of more video processing procedures on the reference video 125, as described in further detail below. However, in some examples, the target video 120 is not generated from the reference video 125 but, rather, the reference video 125 represents an idealized (e.g., error-free) version of the target video 120, such as in scenarios in which the target video 120 is created by a generative artificial intelligence (AI) algorithm based on a description of the reference video 125.

The NN-based video quality evaluation circuitry 105 of the illustrated example also implements (e.g., executes) one or more trained neural networks to process the target video 120 and the reference video 125 to obtain target features and reference features, respectively, from one or more layers of the trained neural network. For example, the NN-based video quality evaluation circuitry 105 may process the target video 120 with a trained 3D CNN to obtain target features corresponding to the target video 120 such that the target features are based on a given one or more layers of the trained 3D CNN. In some examples, the target features correspond to the activations produced at the given one or more layers of the trained 3D CNN when processing the target video 120. Likewise, the NN-based video quality evaluation circuitry 105 may process the reference video 125 with the trained 3D CNN to obtain reference features corresponding to the reference video 125 such that reference features are also based on the given one or more layers of the trained 3D CNN. In some examples, the reference features correspond to the activations produced at the given one or more layers of the trained 3D CNN when processing the reference video 125.

The NN-based video quality evaluation circuitry 105 of the illustrated example includes an example output to provide an example video quality metric 130 for the target video 120. For example, the NN-based video quality evaluation circuitry 105 determines the video quality metric 130 based on the target features and the reference features described above. In some examples, the NN-based video quality evaluation circuitry 105 may combine the target features and the reference features based on a set of weights that are learned (or calibrated) to combine the target features and the reference features to generate the video quality metric 130 such that the video quality metric 130 is representative of human-perceived quality of the target video. In some examples, the NN-based video quality evaluation circuitry 105 additionally or alternatively includes an example output to provide an example error map 135 for the target video 120. The error map 135 may indicate one or more areas of the target video 120 associated with detectable quality degradation. For example, the NN-based video quality evaluation circuitry 105 may determine the error map 135 based on the target features, the reference features and the set of weights described above.

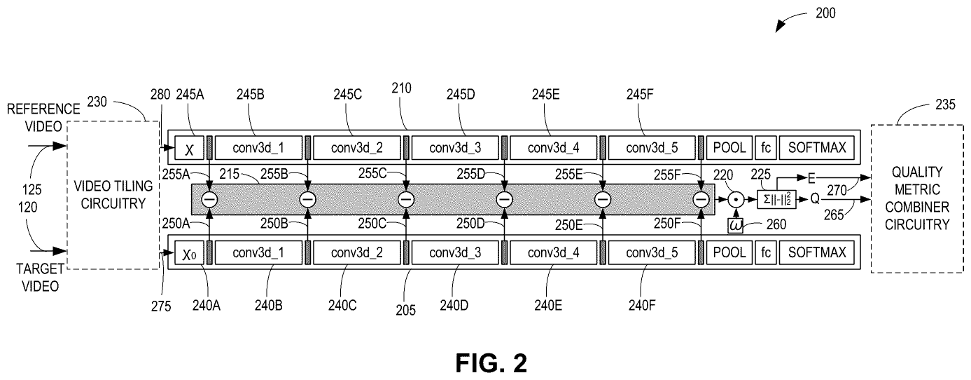

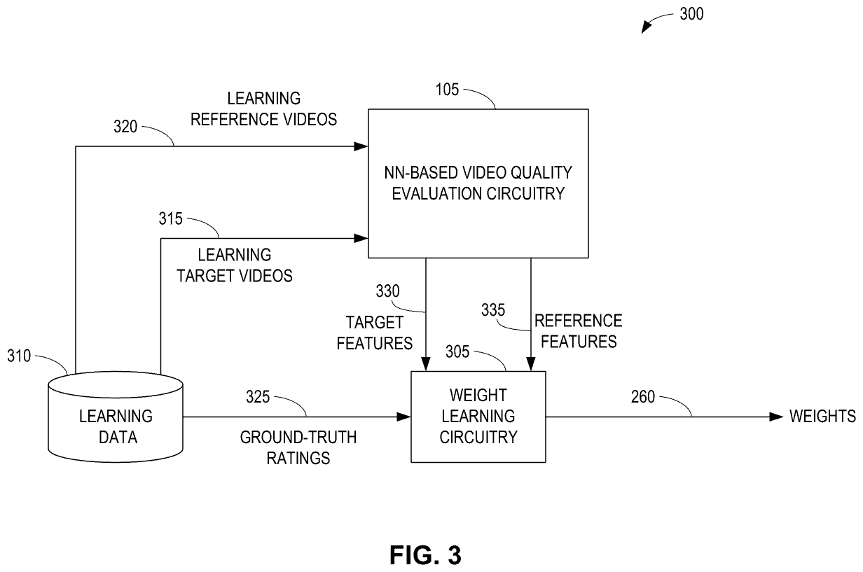

An example implementation of the NN-based video quality evaluation circuitry 105 is illustrated in FIG. 2 and described in detail below. An example system to learn (or calibrate) the set of weights used to determine the video quality metric 130 and/or the error map 135 is illustrated in FIG. 3 and described in detail below.

Returning to FIG. 1, the video processing system 100 of the illustrated example includes the video processing circuitry 110 to generate the target video 120. In some examples, the video processing system 100 implements one or more video processing procedures that generate the target video 120 from the reference video 125. For example, the video processing system 100 may input the reference video 125 to one or more video processing procedures that implement compression algorithm(s), streaming protocol(s), rendering technique(s), neural super-sampling, path tracing, novel-view synthesis, variable rate shading, modern photogrammetry, style transfer, neural denoising, frame interpolation, etc., and/or any combination thereof to produce the target video 120. In some such examples, the target video 120 may exhibit one or more degradations/artifacts relative to the reference video 125.

However, in some examples, the video processing circuitry 110 generates the target video 120 separate from the reference video 125. For example, the target video 120 may be produced by generative AI algorithm from a description of a scene, produced by a computer-generated imagery (CGI) algorithm to virtualize a natural scene, etc. In some such examples, the reference video 125 represents an idealized (e.g., error-free) version of the target video 120 (e.g., such as a source video used to generate the textual description input to the generative AI algorithm, etc.).

In the illustrated example of FIG. 1, the video processing system 100 provides the video quality metric 130 as feedback to the video processing circuitry 110. The video processing circuitry 110 of the illustrated example uses the video quality metric 130 to update its video processing procedure(s) used to generate the target video 120. For example, the video processing circuitry 110 can use the video quality metric 130 to update one or more compression parameters, one or more rendering parameters, etc., and/or any other configurable parameter(s) used by its video processing procedure(s) to generate the target video 120. In some examples, the video processing circuitry 110 updates its video processing procedure(s) based on the video quality metric 130 until negligible improvement in the video quality metric 130 is observed (e.g., based on one or more tolerance thresholds), until one or more stopping criteria are met, etc.

The video processing system 100 of the illustrated example includes the display device 115 to display the video quality metric 130 and/or the error map 135 output from the NN-based video quality evaluation circuitry 105. In some examples, the display device 115 displays the video quality metric 130 as a numerical value, bar graph, etc. In some examples, the video processing system 100 may display the error map 135 as a heat map or video, with the values (e.g., colors) of the heat map/video representative of the numeric values of the error map 135.

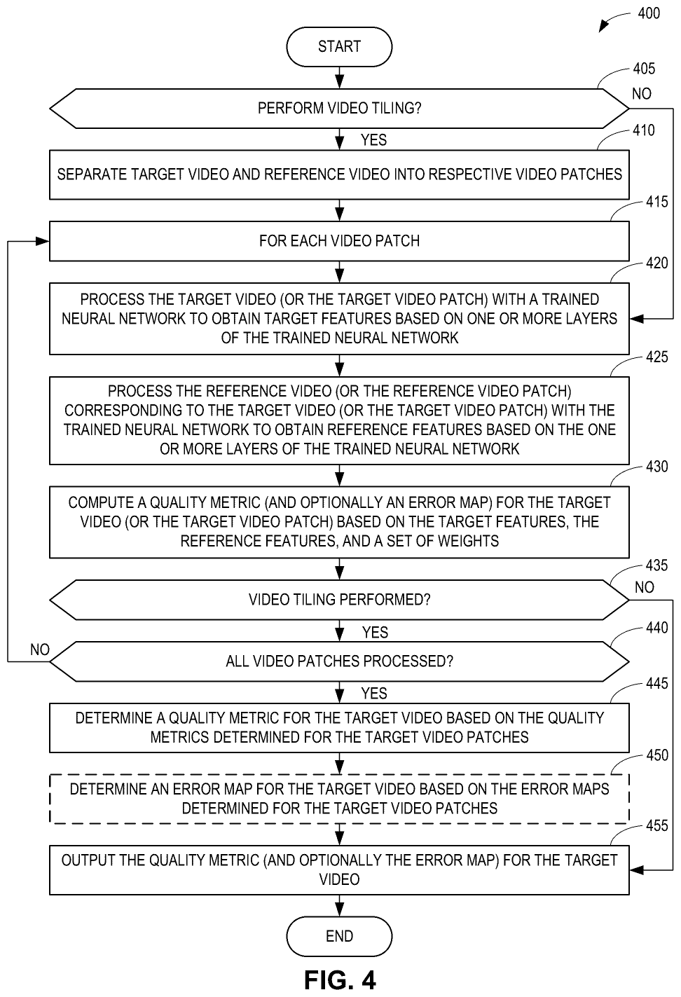

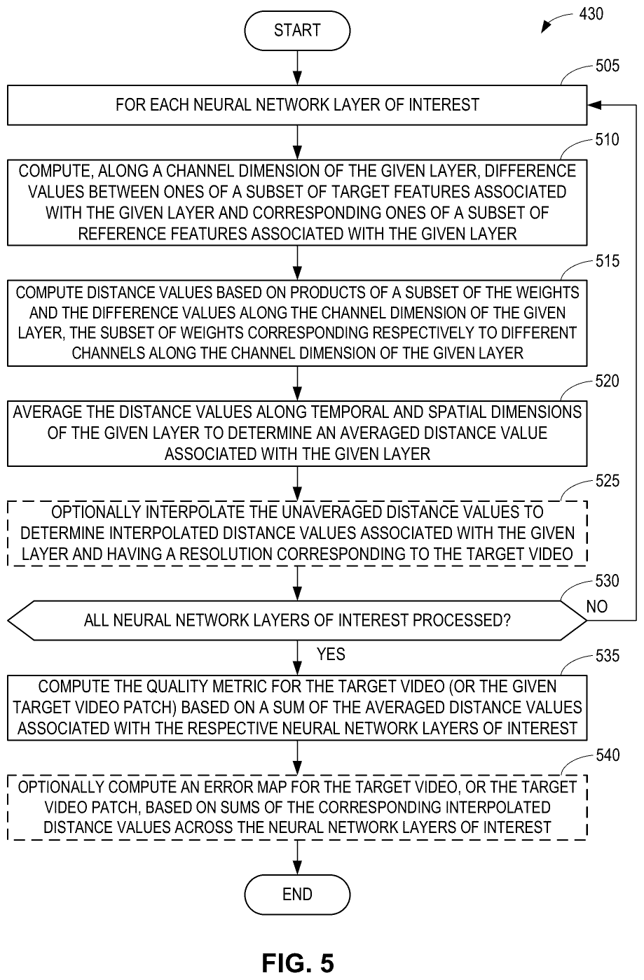

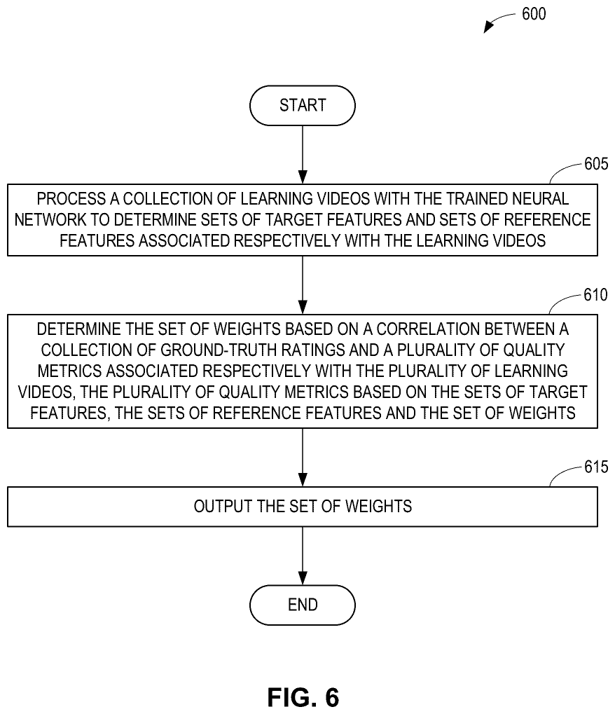

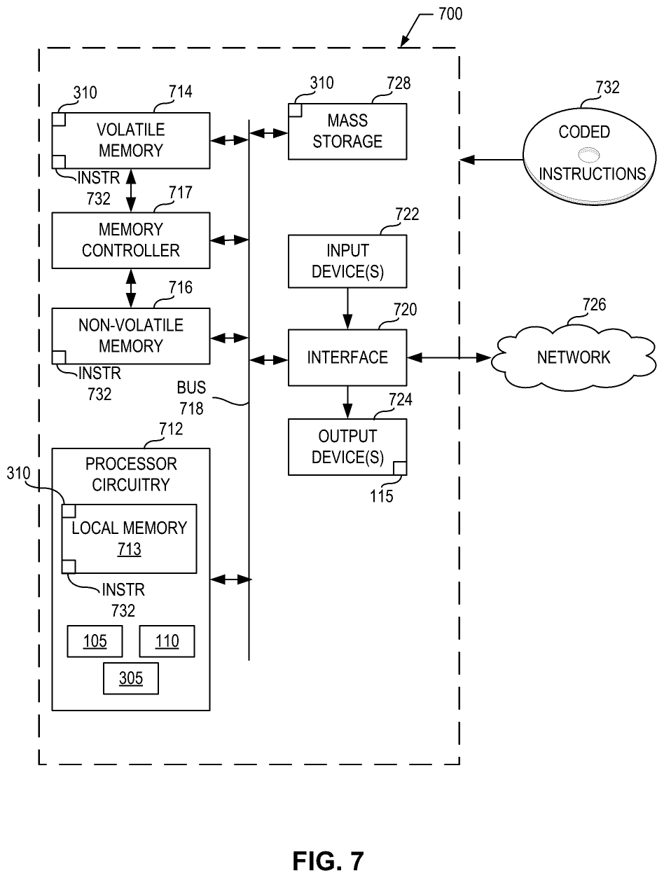

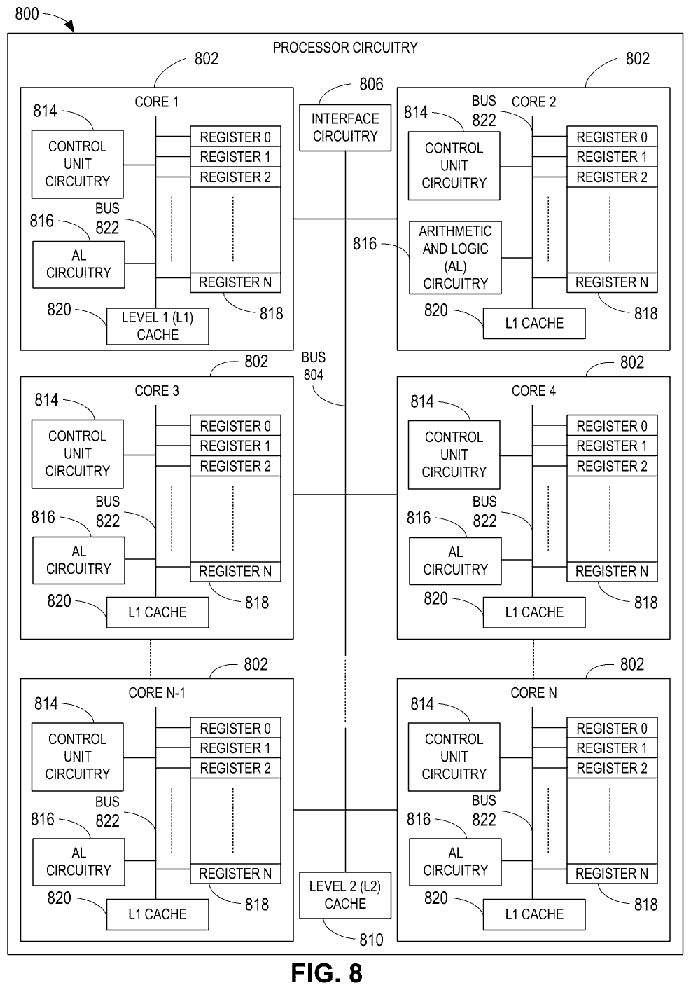

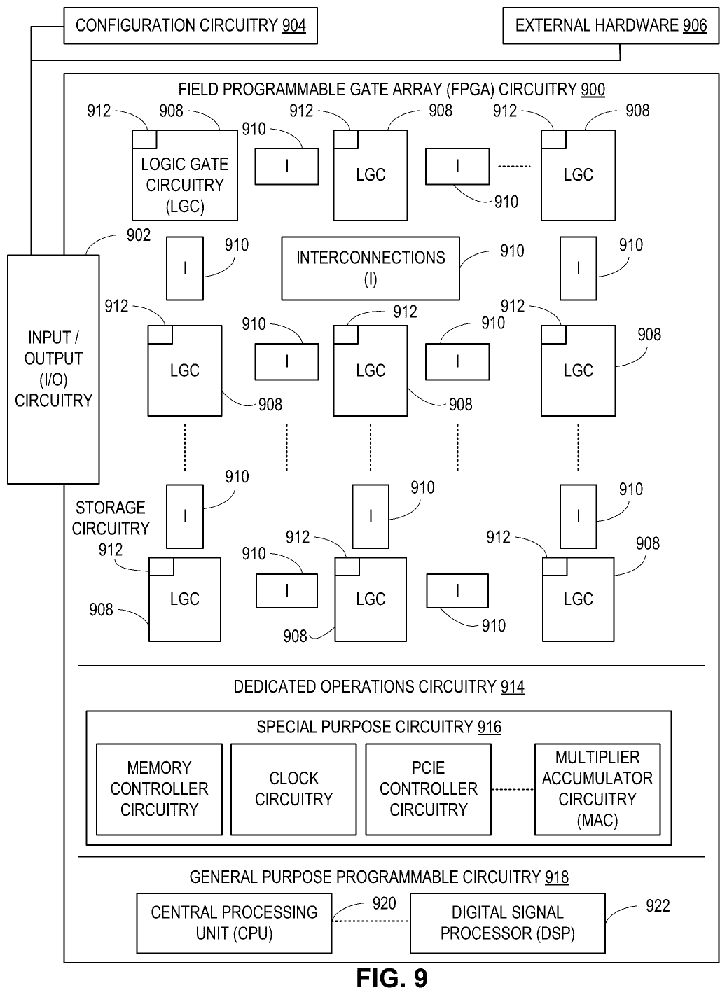

In some examples, the video processing system 100 includes means for determining video quality metrics. For example, the means for determining video quality metrics may be implemented by the NN-based video quality evaluation circuitry 105. In some examples, the NN-based video quality evaluation circuitry 105 may be instantiated by programmable circuitry such as the example programmable circuitry 712 of FIG. 7. For instance, the NN-based video quality evaluation circuitry 105 may be instantiated by the example microprocessor 800 of FIG. 8 executing machine executable instructions such as those implemented by at least blocks 405-455 of FIG. 4, blocks 505-540 of FIG. 5 and/or block 605 of FIG. 6. In some examples, the NN-based video quality evaluation circuitry 105 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the NN-based video quality evaluation circuitry 105 may be instantiated by any other combination of hardware, software, and/or firmware. For example, the NN-based video quality evaluation circuitry 105 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the video processing system 100 includes means for generating videos. For example, the means for generating videos may be implemented by the video processing circuitry 110. In some examples, the video processing circuitry 110 may be instantiated by programmable circuitry such as the example programmable circuitry 712 of FIG. 7. For instance, the video processing circuitry 110 may be instantiated by the example microprocessor 800 of FIG. 8 executing machine executable instructions. In some examples, the video processing circuitry 110 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the video processing circuitry 110 may be instantiated by any other combination of hardware, software, and/or firmware. For example, the video processing circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the video processing system 100 includes means for displaying data. For example, the means for displaying data may be implemented by the display device 115. In some examples, the display device 115 may be instantiated by programmable circuitry such as the example programmable circuitry 712 of FIG. 7. For instance, the display device 115 may be instantiated by the example microprocessor 800 of FIG. 8 executing machine executable instructions. In some examples, the display device 115 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the display device 115 may be instantiated by any other combination of hardware, software, and/or firmware. For example, the display device 115 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the video processing system 100 is illustrated in FIG. 1, one or more of the elements, processes, and/or devices illustrated in FIG. 1 may be combined, divided, re-arranged, omitted, eliminated, and/or implemented in any other way. Further, the example NN-based video quality evaluation circuitry 105, the example video processing circuitry 110, the example display device 115, and/or, more generally, the example video processing system 100 of FIG. 1, may be implemented by hardware alone or by hardware in combination with software and/or firmware. Thus, for example, any of the example NN-based video quality evaluation circuitry 105, the example video processing circuitry 110, the example display device 115, and/or, more generally, the example video processing system 100, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example video processing system 100 may include one or more elements, processes, and/or devices in addition to, or instead of, those illustrated in FIG. 1, and/or may include more than one of any or all of the illustrated elements, processes and devices.

FIG. 2 is a block diagram of an example implementation of the NN-based video quality evaluation circuitry 105 of FIG. 1. The NN-based video quality evaluation circuitry 105 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the NN-based video quality evaluation circuitry 105 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example NN-based video quality evaluation circuitry 105 of FIG. 2 includes a first example neural network 205 to process the target video 120 to determine a set of target features associated with the target video 120, and a second example neural network 210 to process the reference video 125 to determine a set of reference features associated with the reference video 125. As disclosed in further detail below, the neural networks 205 and 210 may be the same neural network that processes the target video 120 and the reference video 125 serially, or may be duplicate neural networks that process the target video 120 and the reference video 125 in parallel. The example NN-based video quality evaluation circuitry 105 of FIG. 2 also includes example difference computation circuitry 215, example weight scaling circuitry 220, and example distance computation circuitry 225. In some examples, the NN-based video quality evaluation circuitry 105 of the illustrated example also includes example video tiling circuitry 230 and example quality metric combiner circuitry 235. The first neural network 205 of the illustrated example can be any type of neural network or other machine learning model capable of providing features associated with an input video. For example, the first neural network 205 can be a 3D-CNN, such as, but not limited to, a R3D CNN, an R(2+1)D CNN, an M3D CNN, etc. As shown in the illustrated example, the first neural network 205 includes example layers 240A-F, which include an example input layer 240A (labeled “x₀” in FIG. 2), an example output layer 240F (labeled “conv3d_5” in FIG. 2), and one or more example intermediate layers 240B-E (labeled “conv3d_1” to “conv3d_4” in FIG. 2).

The layers 240A-F of the first neural network 205 are associated with respective dimensionalities that correspond to the dimensions of the data output by the respective layers 240A-F. For example, the layers 240A-F are each associated with respective spatial height (H) and width (W) dimensions corresponding to the height and width of the data output by the respective layers 240A-F. For example, the input layer 240A (x₀) may have spatial dimensions of H=512 and W=512 corresponding to input video data having frames of 512×512 pixels, but the input layer 240A (x₀) may have other spatial dimensions in other examples. In some examples, the layers 240A-F are each also associated with a respective temporal (F) dimension corresponding to the number of temporal frames included in the data output by the respective layers 240A-F. For example, the input layer 240A (x₀) may have a temporal dimension of F=30 corresponding to the input video data including 30 frames, but the input layer 240A (x₀) may have other temporal dimensions in other examples. In some examples, the layers 240A-F are further each associated with a respective channel (C) dimension corresponding to the number of channels included in the data output by the respective layers 240A-F. For example, the input layer 240A (x₀) may have a channel dimension of C=3 corresponding to the input video data including frames having 3 color channels (e.g., red, green and blue), but the input layer 240A (x₀) may have other channel dimensions in other examples. Example dimensions of the respective layers 240A-F of the first neural network 205 are provided in Table 1 below. In Table 1, the dimensions of the respective layers 240A-F are referred to as the output resolution for those layers 240A-F.

TABLE 1

| Layer | | | | | | |
|---|---|---|---|---|---|---|
| name | input | conv3d_l | conv3d_2 | conv3d_3 | conv3d_4 | conv3d_5 |
| Output resolution | F × W × H × 3 | $F \times \frac{H}{2} \times \frac{W}{2} \times 64$ | $F \times \frac{H}{2} \times \frac{W}{2} \times 64$ | $\frac{F}{2} \times \frac{H}{4} \times \frac{W}{4} \times 128$ | $\frac{F}{4} \times \frac{H}{8} \times \frac{W}{8} \times 256$ | $\frac{F}{8} \times \frac{H}{16} \times \frac{W}{16} \times 512$ |
| Kernel size | | [3 × 7 × 7, 64], stride 1 × 2 × 2 | $[ \begin{matrix}3 \times 3 \times 3 , 64 \\ 3 \times 3 \times 3 , 64\end{matrix} ] \times 2$ | $[ \begin{matrix}3 \times 3 \times 3 , 128 \\ 3 \times 3 \times 3 , 128\end{matrix} ] \times 2$ | $[ \begin{matrix}3 \times 3 \times 3 , 256 \\ 3 \times 3 \times 3 , 256\end{matrix} ] \times 2$ | $[ \begin{matrix}3 \times 3 \times 3 , 512 \\ 3 \times 3 \times 3 , 512\end{matrix} ] \times 2$ |

In the illustrated example, the first neural network 205 is trained (e.g., pre-trained) to perform one or more video analytics and/or other video processing algorithms and/or auxiliary tasks. In some examples, the first neural network 205 is trained (e.g., pre-trained) to perform one or more video analytics and/or other video processing algorithms and/or auxiliary tasks other than video quality evaluation. For example, the first neural network 205 used for video quality evaluation may be pre-trained to perform video analytics tasks such as action recognition, video classification, etc. As such, the weights of the layers 240A-F and any other hyperparameters of the first neural network 205 are trained prior to processing the target video 120.

Likewise, the second neural network 210 of the illustrated example can be any type of neural network or other machine learning model capable of providing features associated with an input video. For example, the second neural network 210 can be a 3D-CNN, such as, but not limited to, a R3D CNN, an R(2+1)D CNN, an M3D CNN, etc. As shown in the illustrated example, the second neural network 210 includes example layers 245A-F, which include an example input layer 245A (labeled “x₀” in FIG. 2), an example output layer 245F (labeled “conv3d_5” in FIG. 2), and one or more example intermediate layers 245B-E (labeled “conv3d_1” to “conv3d_4” in FIG. 2).

As mentioned above, the first neural network 205 of the illustrated example processes the target video 120 to determine a set of target features associated with the target video 120, and the second neural network 210 processes the reference video 125 to determine a set of reference features associated with the reference video 125. In the example NN-based video quality evaluation circuitry 105 of FIG. 2, the second neural network 210 has the same structure as the first neural network 205, and the layers 245A-F of the second neural network 210 are trained to be the same as the layers 240A-F of the second neural network 210. Thus, in some examples, the second neural network 210 is a duplicate of the first neural network 205. In some such examples, the first neural network 205 determines an example set of target features 250A-F associated with the target video 120 in parallel with the second neural network 210 determining an example set of reference features 255A-F associated with the reference video 125. However, in some examples, the first neural network 205 and the second neural network 210 are the same neural network. In some such examples, that same neural network operates serially to process the target video 120 to determine the set of target features 250A-F, followed by processing the reference video 125 to determine the set of reference features 255A-F, or vice versa. The set of target features 250A-F is referred to collectively as the target features 250 or the set of target features 250, and the set of reference features 255A-F is referred to collectively as the reference features 255 or the set of reference features 255.

In the illustrated example, the set of target features 250A-F includes the output activations from the layers 240A-F of the first neural network 205, and the set of reference features 255A-F includes the output activations from the layers 245A-F of the second neural network 210. As such, the set of target features 250A-F includes a number of target features corresponding to the sum of the output resolutions listed in Table 1. Likewise, the set of reference features 255A-F includes a number of reference features corresponding to the sum of the output resolutions listed in Table 1. However, in some examples, the set of target features 250 and the set of reference features 255 are taken from just a selected subset of the layers of the first neural network 205 and the second first neural network 210, with the same subsets of layers selected from the first neural network 205 and the second first neural network 210. For example, the selected subset of layers may be limited to those layers that perform spatiotemporal downsampling, which results in distribution of features at multiple scales while keeping the total number of features relatively. In some examples, the set of target features 250 includes the input target video 120, which corresponds to the input layer 245A of the first neural network 205, and the set of reference features 255 includes the input reference video 125, which corresponds to the input layer 250A of the second neural network 210. Appending the input video to the feature set makes the resulting video quality metric injective, which may be a useful mathematical property for perceptual optimizations.

In the illustrated example of FIG. 2, the set of target features 250 includes the output activations from the layers 240A-F of the first neural network 205. Assuming the layers 240A-F of the first neural network 205 have the dimensions provided in Table 1, then the set of target features 250 has a dimensionality given by Equation 1:

$${\hat{x}}_{0} = \{ {R}^{F \times H \times W \times 3} , {R}^{F \times \frac{H}{2} \times \frac{W}{2} \times 64} , {R}^{F \times \frac{H}{2} \times \frac{W}{2} \times 64} , {R}^{\frac{F}{2} \times \frac{H}{4} \times \frac{W}{4} \times 128} , {R}^{\frac{F}{4} \times \frac{H}{8} \times \frac{W}{8} \times 256} , {R}^{\frac{F}{8} \times \frac{H}{16} \times \frac{W}{16} \times 512} \} \qquad Equation l$$

In Equation 1, \hat{x}₀ represents the set of target features 250. Likewise, in the illustrated example of FIG. 2, the set of reference features 255 includes the output activations from the layers 245A-F of the second neural network 210. Assuming the layers 245A-F of the second neural network 210 have the dimensions provided in Table 1, then the set of reference features 255 has a dimensionality given by Equation 2:

$$\hat{x} = \{ {R}^{F \times H \times W \times 3} , {R}^{F \times \frac{H}{2} \times \frac{W}{2} \times 64} , {R}^{F \times \frac{H}{2} \times \frac{W}{2} \times 64} , {R}^{\frac{F}{2} \times \frac{H}{4} \times \frac{W}{4} \times 128} , {R}^{\frac{F}{4} \times \frac{H}{8} \times \frac{W}{8} \times 256} , {R}^{\frac{F}{8} \times \frac{H}{16} \times \frac{W}{16} \times 512} \} \qquad Equation 2$$

In Equation 2, x₀ represents the set of reference features 255.

The example NN-based video quality evaluation circuitry 105 of FIG. 2 includes the difference computation circuitry 215 to determine difference values corresponding to the differences between the reference features in the set of reference features 255 and corresponding target features in the set of target features 250. In some examples, before computing the difference values between the reference features 255 and the corresponding target features 250, the difference computation circuitry 215 normalizes (e.g., unit-normalizes) the reference features 255 in the channel dimension and normalizes (e.g., unit-normalizes) the target features 250 in the channel dimension. For example, to normalize the reference features 255 in the channel dimension, the difference computation circuitry 215 may normalize the reference features 255 from a given layer of the second neural network 210 across the channel dimension of that given layer. Likewise, to normalize the target features 250 in the channel dimension, the difference computation circuitry 215 may normalize the target features 255 from a given layer of the first neural network 205 across the channel dimension of that given layer.

The example NN-based video quality evaluation circuitry 105 of FIG. 2 includes the weight scaling circuitry 220 to scale the feature difference values output from the difference computation circuitry 215 by an example set of weights 260 to determine scaled difference values. As described above and in further detail below, the set of weights 260 are learned (or calibrated) to combine the target features 250 and the reference features 255 to generate an example video quality metric 130 such that the video quality metric 130 is representative of human-perceived quality of the target video. In the illustrated example, the weight scaling circuitry 220 scales the feature differences output from the difference computation circuitry 215 channel-wise by the set of weights 260. In some such examples, the set of weights 260 includes subsets of weights corresponding respectively to the different neural network layers that generated the target features 250 and the corresponding reference features 255. Furthermore, in some such examples, the subset of weights for a given neural network layer includes a respective weight for each channel in the channel dimension of that given neural network layer. As such, the weight scaling circuitry 220 outputs scaled difference values that include subsets of scaled difference values corresponding respectively to the different neural network layers used to generate the target and reference features. An example system to learn (or calibrate) the set of weights 260 is illustrated in FIG. 3 and described in detail below.

The example NN-based video quality evaluation circuitry 105 of FIG. 2 includes the distance computation circuitry 225 to compute distance values associated with the scaled difference values output from the weight scaling circuitry 220. In the illustrated examples, the distance computation circuitry 225 also averages the distance values to determine one or more averaged distance values. The distance computation circuitry 225 of the illustrated example further determines an example video quality metric 265 based on the averaged distance value(s).

For example, for each neural network layer, the distance computation circuitry 225 may compute the 12 distance values along the channel dimension of the given neural network layer from the subset of scaled difference values corresponding to that given neural network layer. Then, for each neural network layer, the distance computation circuitry 225 may compute an averaged distance value for the given neural network layer from the l₂ distance values computed along the channel dimension of that given neural network layer. Next, the distance computation circuitry 225 may sum the averaged distance values across the different neural network layers to determine an accumulated distance value for the input target video 120, and may determine the video quality metric 265 for the input target video 120 based on that accumulated distance value.

Mathematically, operation of the example NN-based video quality evaluation circuitry 105 of FIG. 2 can be described as follows. Let x and x₀ be the reference video 125 and the target (e.g., distorted) video 120 of spatiotemporal resolution F×H×W, respectively. Also, let N be a 3D-CNN that implements the neural networks 205-210 used for feature decomposition. The difference computation circuitry 215 extracts the reference features 255 and the target features 250 from L layers of the neural networks 205-210, and unit-normalizes the features in channel dimension to get \hat{x}^{l}, \hat{x}₀^{l}∈R^{F}^{ₗ}^{×H}^{ₗ}^{×W}^{ₗ}^{×C}^{ₗ} for layer l, as described above, where Fₗ×Hₗ×Wₗ×Cₗ is the resolution of the feature stack at layer l. The weight scaling circuitry 220 scale the differences of the normalized features (e.g. normalized activations) channel-wise by the set of weights 260, as described above, with the weights 260 represented by a weight vector ωₗ∈R^{C}^{ₗ}. The distance computation circuitry 225 then computes the l₂ distance values, as described above, and then averages the distance value spatiotemporally and sums the averaged distance values channel-wise to determine the video quality metric 265. In summary, the foregoing operations performed by the NN-based video quality evaluation circuitry 105 can be represented mathematically by Equation 3:

$$q ( x , {x}_{0} ) = α - {\sum }_{l} \frac{1}{{F}_{l} {H}_{l} {W}_{l}} {\sum }_{{F}_{l} , {H}_{l} , {W}_{l}} {‖ {w}_{l} ⊙ ( {\hat{x}}_{{F}_{l} {H}_{l} {W}_{l}}^{l} - {\hat{x}}_{0 {F}_{l} {H}_{l} {W}_{l}}^{l} ) ‖}_{2}^{2} \qquad Equation 3$$

In Equation 3, q(x, x₀) denotes the video quality metric 265, and a denotes an offset applied by the distance computation circuitry 225 to the accumulated average distance value determined for the target video 120. In some examples, the offset a corresponds to a best possible quality score on a video quality scale (e.g., the best possible rating of 100 or some other value). In some examples, the distance computation circuitry 225 limits the output video quality metric q(x, x₀) to be non-negative by setting negative values to 0. In some examples, the distance computation circuitry 225 allows the video quality metric q(x, x₀) to have negative values.

In the illustrated example of FIG. 2, the distance computation circuitry 225 also outputs an example error map 270 for the input target video 120. In some examples, the distance computation circuitry 225 determines the error map 270 by skipping the spatiotemporal averaging described above, and by interpolating the feature stack at each layer to the resolution of input video 120. Mathematically, the foregoing operations performed by the NN-based video quality evaluation circuitry 105 can be represented mathematically by Equation 4:

$$e ( x , {x}_{0} ) = {\sum }_{l} ↑ {( {‖ {ω}_{l} ⊙ ( {\hat{x}}_{{F}_{l} {H}_{l} {W}_{l}}^{l} - {\hat{x}}_{0 {F}_{l} {H}_{l} {W}_{l}}^{l} ) ‖}_{2}^{2} )}_{F H W} \qquad Equation 4$$

In Equation 4, e(x, x₀) denotes the error map 270, and the operation ↑( )_{FHW} denotes trilinear interpolation to F×H×W resolution.

In some examples, the target video 120 and the corresponding reference video 125 may have resolutions that are larger than the dimensionality supported by the input layer of the neural network implementing the neural networks 205-210. In some such examples, the NN-based video quality evaluation circuitry 105 of FIG. 2 includes the video tiling circuitry 230 to tile, or separate, the target video 120 and the corresponding reference video 125 into example target video patches 275 and corresponding example reference video patches 280, respectively, having a patch resolution that fits in the memory and, thus, the dimensionality supported by the input layer of the neural network implementing the neural networks 205-210. For example, the video tiling circuitry 230 to tile, or separate, the target video 120 and the reference video 125 into target video patches 275 and reference video patches 280, respectively, having a patch resolution of F×H×W=30×512×512, or some other resolution.

In example implementations including the video tiling circuitry 230, the NN-based video quality evaluation circuitry 105 of FIG. 2 also includes the quality metric combiner circuitry 235 to combine the intermediate video quality metrics 265 and the individual error maps 270 output from the distance computation circuitry 225 for the individual target video patches 275 into the overall video quality metric 130 and the overall error map, respectively, for the target video 120. For example, the quality metric combiner circuitry 235 may set the overall video quality metric 130 to be equal to (i) the smallest, or minimum, value among the intermediate video quality metrics 265, (ii) an average of the intermediate video quality metrics 265, (iii) a median of the intermediate video quality metrics 265, etc. In some examples, the quality metric combiner circuitry 235 may determine the overall error map by recombining the intermediate error maps 270 based on their corresponding patch locations in the overall video. However, in examples in which the target video 120 and the reference video 125 are not tiled, the quality metric combiner circuitry 235 can set the overall video quality metric 130 equal to the video quality metric 265, and can set the overall error map 135 equal to the error map 270.

In some examples, the NN-based video quality evaluation circuitry 105 includes means for performing neural network processing. For example, the means for performing neural network processing may be implemented by the neural networks 205-210. In some examples, the neural networks 205-210 may be instantiated by programmable circuitry such as the example programmable circuitry 712 of FIG. 7. For instance, the neural networks 205-210 may be instantiated by the example microprocessor 800 of FIG. 8 executing machine executable instructions such as those implemented by at least blocks 420-425 of FIG. 4. In some examples, the neural networks 205-210 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the neural networks 205-210 may be instantiated by any other combination of hardware, software, and/or firmware. For example, the neural networks 205-210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the NN-based video quality evaluation circuitry 105 includes means for computing differences between features. For example, the means for computing differences between features may be implemented by the difference computation circuitry 215. In some examples, the difference computation circuitry 215 may be instantiated by programmable circuitry such as the example programmable circuitry 712 of FIG. 7. For instance, the difference computation circuitry 215 may be instantiated by the example microprocessor 800 of FIG. 8 executing machine executable instructions such as those implemented by at least block 510 of FIG. 5. In some examples, the difference computation circuitry 215 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the difference computation circuitry 215 may be instantiated by any other combination of hardware, software, and/or firmware. For example, the difference computation circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the NN-based video quality evaluation circuitry 105 includes means for scaling features with weights. For example, the means for scaling features with weights may be implemented by the weight scaling circuitry 220. In some examples, the weight scaling circuitry 220 may be instantiated by programmable circuitry such as the example programmable circuitry 712 of FIG. 7. For instance, the weight scaling circuitry 220 may be instantiated by the example microprocessor 800 of FIG. 8 executing machine executable instructions such as those implemented by at least block 515 of FIG. 5. In some examples, the weight scaling circuitry 220 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the weight scaling circuitry 220 may be instantiated by any other combination of hardware, software, and/or firmware. For example, the weight scaling circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the NN-based video quality evaluation circuitry 105 includes means for computing distances. For example, the means for computing distances may be implemented by the distance computation circuitry 225. In some examples, the distance computation circuitry 225 may be instantiated by programmable circuitry such as the example programmable circuitry 712 of FIG. 7. For instance, the distance computation circuitry 225 may be instantiated by the example microprocessor 800 of FIG. 8 executing machine executable instructions such as those implemented by at least blocks 515-525 of FIG. 5. In some examples, the distance computation circuitry 225 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the distance computation circuitry 225 may be instantiated by any other combination of hardware, software, and/or firmware. For example, the distance computation circuitry 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the NN-based video quality evaluation circuitry 105 includes means for tiling videos. For example, the means for tiling videos may be implemented by the video tiling circuitry 230. In some examples, the video tiling circuitry 230 may be instantiated by programmable circuitry such as the example programmable circuitry 712 of FIG. 7. For instance, the video tiling circuitry 230 may be instantiated by the example microprocessor 800 of FIG. 8 executing machine executable instructions such as those implemented by at least blocks 405-415 of FIG. 4. In some examples, the video tiling circuitry 230 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the video tiling circuitry 230 may be instantiated by any other combination of hardware, software, and/or firmware. For example, the video tiling circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the NN-based video quality evaluation circuitry 105 includes means for combining metrics. For example, the means for combining metrics may be implemented by the quality metric combiner circuitry 235. In some examples, the quality metric combiner circuitry 235 may be instantiated by programmable circuitry such as the example programmable circuitry 712 of FIG. 7. For instance, the quality metric combiner circuitry 235 may be instantiated by the example microprocessor 800 of FIG. 8 executing machine executable instructions such as those implemented by at least blocks 445-450 of FIG. 4. In some examples, the quality metric combiner circuitry 235 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the quality metric combiner circuitry 235 may be instantiated by any other combination of hardware, software, and/or firmware. For example, the quality metric combiner circuitry 235 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the NN-based video quality evaluation circuitry 105 of FIG. 1 is illustrated in FIG. 2, one or more of the elements, processes, and/or devices illustrated in FIG. 2 may be combined, divided, re-arranged, omitted, eliminated, and/or implemented in any other way. Further, the example neural networks 205-210, the example difference computation circuitry 215, the example weight scaling circuitry 220, the example distance computation circuitry 225, the example video tiling circuitry 230, the example quality metric combiner circuitry 235, and/or, more generally, the example NN-based video quality evaluation circuitry 105 of FIG. 2, may be implemented by hardware alone or by hardware in combination with software and/or firmware. Thus, for example, any of the example neural networks 205-210, the example difference computation circuitry 215, the example weight scaling circuitry 220, the example distance computation circuitry 225, the example video tiling circuitry 230, the example quality metric combiner circuitry 235, and/or, more generally, the example NN-based video quality evaluation circuitry 105 of FIG. 2, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example NN-based video quality evaluation circuitry 105 of FIG. 2 may include one or more elements, processes, and/or devices in addition to, or instead of, those illustrated in FIG. 2, and/or may include more than one of any or all of the illustrated elements, processes and devices.

FIG. 3 is a block diagram of an example weight learning system 300 to learn (or calibrate) a set or weights used by the NN-based video quality evaluation circuitry 105 of FIGS. 1 and/or 2. The weight learning system 300 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the weight learning system 300 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example weight learning system 300 of FIG. 3 includes the NN-based video quality evaluation circuitry 105, example weight learning circuitry 305, and example learning data storage 310. The learning data storage 310 includes a set of learning videos that include example learning target videos 315 and corresponding example learning reference videos 320, which may be natural videos, computer-generated videos (e.g., video game content, AI-generated content), etc. In some examples, the learning target videos 315 are videos exhibiting one or more distortions, artifacts, etc., and the learning reference videos 320 are corresponding distortion-free videos, artifact-free videos, etc. The learning data storage 310 also includes respective example ground-truth video quality ratings 325 for the learning target videos 315. For example, the ground-truth video quality ratings 325 can be numerical values, scores, etc., specified by one or more humans that perceive and evaluate the quality of the learning target videos 315.

In the illustrated example of FIG. 3, the weight learning circuitry 305 causes the NN-based video quality evaluation circuitry 105 to process the learning target videos 315 and the corresponding learning reference videos 320 with a trained neural network (e.g., such as the trained neural network implementing the neural networks 205-210), as described above, to determine sets of target features 330 and sets of reference features 335 associated respectively with the learning videos. As described above, a set of target features 330 for a given learning target video 315 has a dimensionality given by Equation 1, which is repeated below for convenience as Equation 5:

$${\hat{x}}_{0} = \{ {R}^{F \times H \times W \times 3} , {R}^{F \times \frac{H}{2} \times \frac{W}{2} \times 64} , {R}^{F \times \frac{H}{2} \times \frac{W}{2} \times 64} , {R}^{\frac{F}{2} \times \frac{H}{4} \times \frac{W}{4} \times 128} , {R}^{\frac{F}{4} \times \frac{H}{8} \times \frac{W}{8} \times 256} , {R}^{\frac{F}{8} \times \frac{H}{16} \times \frac{W}{16} \times 512} \} \qquad Equation 5$$

Likewise, a set of reference features 335 for a given learning reference video 320 has a dimensionality given by Equation 2, which is repeated below for convenience as Equation 6:

$$\hat{x} = \{ {R}^{F \times H \times W \times 3} , {R}^{F \times \frac{H}{2} \times \frac{W}{2} \times 64} , {R}^{F \times \frac{H}{2} \times \frac{W}{2} \times 64} , {R}^{\frac{F}{2} \times \frac{H}{4} \times \frac{W}{4} \times 128} , {R}^{\frac{F}{4} \times \frac{H}{8} \times \frac{W}{8} \times 256} , {R}^{\frac{F}{8} \times \frac{H}{16} \times \frac{W}{16} \times 512} \} \qquad Equation 6$$

In some examples, the weight learning circuitry 305 stores the sets of target features 330 and sets of reference features 335 for the complete set of learning videos for subsequent use in determining the set of weights 260.

In the illustrated example of FIG. 3, the weight learning circuitry 305 then determines the set of weights 260 based on the sets of target features 330, the sets of reference features 335 and the ground-truth ratings 325 associated respectively with the learning target videos 315. In some examples, the weight learning circuitry 305 determines the set of weights 260 based on a correlation between the ground-truth ratings 325 and video quality metrics associated respectively with learning target videos 315. For example, weight learning circuitry 305 may implement functionality similar to the weight scaling circuitry 220, and the distance computation circuitry 225 of NN-based video quality evaluation circuitry 105 the video quality metrics for the respective learning target videos 315 based on the sets of target features 330, the sets of reference features 335 and the set of weights 260.

For example, given the sets of target features 330 and the sets of reference features 335 obtained for the learning target videos 315 and the learning reference videos 320, the weight learning circuitry 305 may iteratively adjust the set of weights 260 to maximize the correlation, such as a Pearson correlation, between the ground-truth ratings 325 and the latest video quality metrics determined from the sets of target features 330 and the sets of reference features 335 using the adjusted weights 260. In some examples, the weight learning circuitry 305 continues to iteratively adjust the set of weights 260 (or use any other numerical method) until the adjusted weights 260 converge and yield a maximum correlation (e.g., within a convergence threshold or range), an iteration limit is reached, etc.

Mathematically, operation of the weight learning circuitry 305 can be described as follows. The set of weights 260 includes a number of weights corresponding to the number of channels over the layers represented in the sets of target features 330 and the sets of reference features 335. In the example of Equations 5 and 6, the total number of channels is 3+64+64+128+256+512=1027. This wields 1027 free parameters (w=R¹⁰²⁷), which the weight learning circuitry 305 determines numerically by maximizing the correlation between the video quality metric predictions, denoted qₓ_{₀}^{D}, and ground-truth ratings 325, denoted a hₓ_{₀}^{D}, on the video quality assessment dataset D including the learning videos 315-320, given by Equation 7:

$${\underbrace{min}}_{w} {\sum }_{D} 1 - PLCC ( {h}_{{x}_{0}}^{D} , {q}_{{x}_{0}}^{D} ) \qquad Equation 7$$

In Equation 7, PLCC denotes Pearson correlation. Note that the neural network weights are frozen after pre-training and the set of weights 260 (e.g., w) are determined (e.g., optimized) according to Equation 7. This approach reduces the number of free parameters and thus mitigates the risk of over-fitting.

In some examples, the weight learning system 300 includes means for learning weights. For example, the means for learning weights may be implemented by the weight learning circuitry 305. In some examples, the weight learning circuitry 305 may be instantiated by programmable circuitry such as the example programmable circuitry 712 of FIG. 7. For instance, the weight learning circuitry 305 may be instantiated by the example microprocessor 800 of FIG. 8 executing machine executable instructions such as those implemented by at least block 605-615 of FIG. 6. In some examples, the weight learning circuitry 305 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the weight learning circuitry 305 may be instantiated by any other combination of hardware, software, and/or firmware. For example, the weight learning circuitry 305 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the weight learning system 300 is illustrated in FIG. 3, one or more of the elements, processes, and/or devices illustrated in FIG. 3 may be combined, divided, re-arranged, omitted, eliminated, and/or implemented in any other way. Further, the example NN-based video quality evaluation circuitry 105, the example weight learning circuitry 305, and/or, more generally, the example weight learning system 300 of FIG. 3, may be implemented by hardware alone or by hardware in combination with software and/or firmware. Thus, for example, any of the example NN-based video quality evaluation circuitry 105, the example weight learning circuitry 305, and/or, more generally, the example learning system 300, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example weight learning system 300 of FIG. 3 may include one or more elements, processes, and/or devices in addition to, or instead of, those illustrated in FIG. 3, and/or may include more than one of any or all of the illustrated elements, processes and devices.

Flowchart(s) representative of example machine-readable instructions, which may be executed by programmable circuitry to implement and/or instantiate the video processing system 100 and/or the weight learning system 300 of FIGS. 1-3 and/or representative of example operations which may be performed by programmable circuitry to implement and/or instantiate the video processing system 100 and/or the weight learning system 300 of FIGS. 1-3, are shown in FIGS. 4-6. The machine-readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 4-6, many other methods of implementing the example the video processing system 100 and/or the weight learning system 300 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 4-6 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 4 is a flowchart representative of example machine-readable instructions and/or example operations 400 that may be executed, instantiated, and/or performed by programmable circuitry to implement the NN-based video quality evaluation circuitry 105 of FIG. 2. The example machine-readable instructions and/or the example operations 400 of FIG. 4 begin at block 405 at which the NN-based video quality evaluation circuitry 105 determines whether video tiling is to be performed. If video tiling is to be performed (corresponding to the “YES” output of block 405), then at block 410 the video tiling circuitry 230 of the NN-based video quality evaluation circuitry 105 tiles, or separates, the target video 120 and the reference video 125 into respective target video patches 275 and respective reference video patches 280, as described above. At block 415, the video tiling circuitry 230 then causes processing to iterate through the video patches.

Next, at block 420, the NN-based video quality evaluation circuitry 105 processes the target video 120 (or the current target video patch 275) with a trained neural network (e.g., the neural network 205) to obtain the target features 250 based on one or more layers of the trained neural network (e.g., one or more of the layers 240A-F), as described above. At block 425, the NN-based video quality evaluation circuitry 105 processes the reference video 130 (or the current reference video patch 280) corresponding to the target video 120 (or the current target video patch 275) with the trained neural network (e.g., the neural network 210) to obtain the reference features 255 based on the one or more layers of the trained neural network (e.g., one or more of the layers 245A-F), as described above. At block 430, the NN-based video quality evaluation circuitry 105 computes the quality metric 265 (and optionally the error map 270) for the target video 120 (or the current target video patch 275) based on the target features 250, the reference features 255, and the set of weights 260, as described. Example machine-readable instructions and/or the example operations that may be used to implement the processing at block 430 are illustrated in FIG. 5 and described in detail below.

At block 435, the NN-based video quality evaluation circuitry 105 determines whether video tiling was performed. If video tiling was performed (corresponding to the “YES” output of block 435), at block 440, the NN-based video quality evaluation circuitry 105 determines whether all video patches have been processed. If all video patches have not been processed (corresponding to the “NO” output of block 440), processing returns to block 415 and blocks subsequent thereto to process the next target and reference video patches. Otherwise, if all video patches have been processed (corresponding to the “YES” output of block 440), at block 445, the metric combiner circuitry 235 of the NN-based video quality evaluation circuitry 105 determine the overall quality metric 130 for the target video 120 based on the intermediate quality metrics 265 determined for the target video patches 275, as described above. At block 450, the metric combiner circuitry 235 determines the overall error map 135 for target video 120 based on the intermediate error maps 270 determined for the target video patches 275, as described above. At block 455, the NN-based video quality evaluation circuitry 105 outputs the quality metric 130 and the error map 135 for the target video 120, as described above. The example machine-readable instructions and/or the example operations 400 then end.

FIG. 5 is a flowchart representative of example machine-readable instructions and/or example operations 430 that may be executed, instantiated, and/or performed by programmable circuitry to implement processing at block 430 of FIG. 4. The example machine-readable instructions and/or the example operations 430 of FIG. 5 begin at block 505 at which NN-based video quality evaluation circuitry 105 begins iterating over the neural network layers selected to provide features to be used to determine the quality metric 130 and the error map 135 for the target video 120. At block 510, the difference computation circuitry 215 of the NN-based video quality evaluation circuitry 105 computes, along a channel dimension of the given layer, difference values between ones of a subset of the target features 250 associated with the given layer and corresponding ones of a subset of the reference features 255 associated with the given layer, as described above. At block 515, the distance computation circuitry 225 of the NN-based video quality evaluation circuitry 105 compute distance values based on products of a subset of the weights 260 and the difference values along the channel dimension of the given layer, as described above. As also described above, the weights in the subset of the weights 260 correspond respectively to different channels along the channel dimension of the given layer. At block 515, the weight scaling circuitry 220 of the NN-based video quality evaluation circuitry 105 determines the products of the subset of the weights 260 and the difference values for the given layer, as described above.

At block 520, the difference computation circuitry 215 averages the distance values along temporal and spatial dimensions of the given layer to determine an averaged distance value associated with the given layer, as described above. At block 525, the difference computation circuitry 215 interpolates the unaveraged distance values to determine interpolated distance values associated with the given layer and having a resolution corresponding to the target video 120, as described above. At block 530, the NN-based video quality evaluation circuitry 105 determines whether all selected neural network layers of interest have been processed. If all layers have not been processed (corresponding to the “NO” output of block 530), processing returns to block 505 and blocks subsequent thereto at which the next neural network layer is processed.

Otherwise, at block 535, the difference computation circuitry 215 computes the quality metric 130 for the target video 120 (or the quality metric 265 for the given target video patch 275) based on a sum of the averaged distance values associated with the respective neural network layers of interest, as described above. At block 540, the difference computation circuitry 215 computes the error map 135 for the target video 120 (or the error map 270 for the target video patch 275) based on sums of the corresponding interpolated distance values across the neural network layers of interest, as described above. The example machine-readable instructions and/or the example operations 430 then end.

FIG. 6 is a flowchart representative of example machine-readable instructions and/or example operations 6 that may be executed, instantiated, and/or performed by programmable circuitry to implement the weight learning system 300 of FIG. 3. The example machine-readable instructions and/or the example operations 600 of FIG. 6 begin at block 605 at which the weight learning circuitry 305 of the weight learning system 300 causes the NN-based video quality evaluation circuitry 105 to process a collection of learning videos (e.g., learning target and reference videos 315-320) with a trained neural network to determine sets of target features 330 and sets of reference features 335 associated respectively with the learning videos, as described above. At block 610, the weight learning circuitry 305 determines the set of weights 260 (e.g., numerically, iteratively, etc.) based on a correlation between a collection of ground-truth ratings 325 and determined quality metrics associated respectively with the learning videos as described above. At block 610, the weight learning circuitry 305 determines the quality metrics based on the sets of target features 330, the sets of reference features 335 and the set of weights 260. At block 615, the weight learning circuitry 305 outputs the learning set of weights 260, as described above. The example machine-readable instructions and/or the example operations 600 then end.

FIG. 7 is a block diagram of an example programmable circuitry platform 700 structured to execute and/or instantiate the example machine-readable instructions and/or the example operations of FIGS. 4-6 to implement the video processing system 100 and/or the weight learning system 300 of FIGS. 1-3. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the example NN-based video quality evaluation circuitry 105, the example video processing circuitry 110 and/or the example weight learning circuitry 305.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716. In some examples, the local memory 713 implements the learning data storage 310. In some examples, the main memory 714 implements the learning data storage 310.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU. In the illustrated example, the output device(s) 724 implement the display device 115.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, the mass storage discs or devices 728 implement the learning data storage 310.

The machine-readable instructions 732, which may be implemented by the machine-readable instructions of FIGS. 4-6, may be stored in the mass storage device 728, in the volatile memory 714, in the non-volatile memory 716, and/or on at least one non-transitory computer-readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 4-6 to effectively instantiate the circuitry of FIGS. 1-3 as logic circuits to perform operations corresponding to those machine-readable instructions. In some such examples, the circuitry of FIGS. 1-3 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine-readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine-readable instructions and/or operations represented by the flowcharts of FIGS. 4-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine-readable instructions. However, once configured, the FPGA circuitry 900 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine-readable instructions represented by the flowchart(s) of FIGS. 4-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 4-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-6. As such, the FPGA circuitry 900 may be configured and/or structured to effectively instantiate some or all of the operations/functions corresponding to the machine-readable instructions of the flowchart(s) of FIGS. 4-6 as dedicated logic circuits to perform the operations/functions corresponding to those software instructions in a dedicated manner analogous to an ASIC. Therefore, the FPGA circuitry 900 may perform the operations/functions corresponding to the some or all of the machine-readable instructions of FIGS. 4-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine-readable instructions of FIGS. 4-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine-readable instructions represented by the flowchart(s) of FIGS. 4-6 to perform first operation(s)/function(s), the FPGA circuitry 900 of FIG. 9 may be configured and/or structured to perform second operation(s)/function(s) corresponding to a second portion of the machine-readable instructions represented by the flowcharts of FIG. 4-6, and/or an ASIC may be configured and/or structured to perform third operation(s)/function(s) corresponding to a third portion of the machine-readable instructions represented by the flowcharts of FIGS. 4-6.

It should be understood that some or all of the circuitry of FIGS. 1-3 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIGS. 1-3 may be instantiated, for example, in one or more threads executing concurrently and/or in series. For example, the microprocessor 800 of FIG. 8 may execute machine-readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIGS. 1-3 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

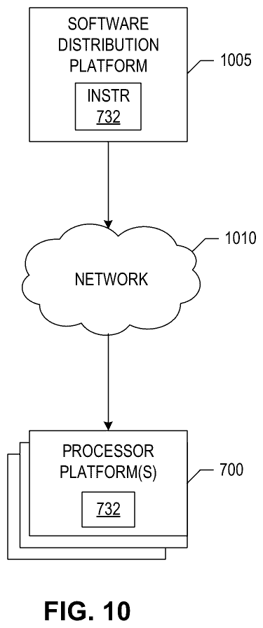

A block diagram illustrating an example software distribution platform 1005 to distribute software such as the example machine-readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine-readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine-readable instructions 732, which may correspond to the example machine-readable instructions of FIGS. 4-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 732 from the software distribution platform 1005. For example, the software, which may correspond to the example machine-readable instructions of FIG. 4-6, may be downloaded to the example programmable circuitry platform 700, which is to execute the machine-readable instructions 732 to implement the video processing system 100 and/or the weight learning system 300. In some examples, one or more servers of the software distribution platform 1005 periodically offer, transmit, and/or force updates to the software (e.g., the example machine-readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that evaluate video quality based on trained neural networks. Disclosed systems, apparatus, articles of manufacture, and methods improve the efficiency of using a computing device by utilizing a neural network to determine a video quality metric and, optionally, an error map that can accurately mimic human perception of a target video, including evaluation of the overall quality and indicating area(s) associated with detectable degradation. Moreover, such neural network video quality evaluation techniques can be fully automated and deployed in the field to provide feedback (e.g., the video quality metric, the error map, etc.) to adjust video processing algorithms (e.g. compression algorithms, streaming protocols, rendering techniques, etc.) to achieve an acceptable viewer experience. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry, instructions, and at least one programmable circuit to be programmed based on the instructions to obtain, using a trained neural network, target features corresponding to a target video, the target features based on one or more layers of the trained neural network, obtain, using the trained neural network, reference features corresponding to a reference video, the reference features based on the one or more layers of the trained neural network, the reference video associated with the target video, and output a quality metric for the target video based on the target features, the reference features, and a set of weights.

Example 2 includes any preceding clause(s) of example 1, wherein one or more of the at least one programmable circuit is to obtain, using the trained neural network, sets of target features and sets of reference features associated respectively with a plurality of learning videos, and determine the set of weights based on the sets of target features, the sets of reference features and a plurality of ground-truth ratings associated respectively with the plurality of learning videos.

Example 3 includes any preceding clause(s) of any one or more of Examples 1-2, wherein one or more of the at least one programmable circuit is to determine the set of weights based on a correlation between the plurality of ground-truth ratings and a plurality of quality metrics associated respectively with the plurality of learning videos, the plurality of quality metrics based on the sets of target features, the sets of reference features and the set of weights.

Example 4 includes any preceding clause(s) of any one or more of Examples 1-3, wherein one or more of the at least one programmable circuit is to determine the set of weights to maximize the correlation between the plurality of ground-truth ratings and the plurality of quality metrics.

Example 5 includes any preceding clause(s) of any one or more of Examples 1-4, wherein the correlation is a Pearson correlation.

Example 6 includes any preceding clause(s) of any one or more of Examples 1-5, wherein the one or more layers of the trained neural network include a first layer of the trained neural network, the target features include a subset of target features associated with the first layer, the reference features include a subset of reference features associated with the first layer, and one or more of the at least one programmable circuit is to compute difference values between ones of the subset of target features and corresponding ones of the subset of reference features along a channel dimension of the first layer, compute distance values based on products of a subset of the weights and the difference values along the channel dimension of the first layer, the subset of the weights corresponding respectively to different channels along the channel dimension of the first layer, and compute the quality metric based on the distance values.

Example 7 includes any preceding clause(s) of any one or more of Examples 1-6, wherein one or more of the at least one programmable circuit is to average the distance values along temporal and spatial dimensions of the first layer to determine an averaged distance value associated with the first layer, and compute the quality metric based on the averaged distance value.

Example 8 includes any preceding clause(s) of any one or more of Examples 1-7, wherein the average distance value is a first averaged distance value, the one or more layers of the trained neural network includes a plurality of layers of the trained neural network, and one or more of the at least one programmable circuit is to compute a plurality of averaged distance values associated respectively with the plurality of layers of the trained neural network, the plurality of averaged distance values including the first averaged distance value, the plurality of layers including the first layer, and compute the quality metric based on a sum of the plurality of averaged distance values.

Example 9 includes any preceding clause(s) of any one or more of Examples 1-8, wherein one or more the at least one programmable circuit is to interpolate the distance values to determine interpolated distance values having a resolution corresponding to the target video, and output an error map based on the interpolated distance values.

Example 10 includes any preceding clause(s) of any one or more of Examples 1-9, wherein one or more the at least one programmable circuit is to perform trilinear interpolation on the distance values to determine the interpolated distance values.

Example 11 includes any preceding clause(s) of any one or more of Examples 1-10, wherein the set of weights are different from neural network weights included in the trained neural network.

Example 12 includes any preceding clause(s) of any one or more of Examples 1-11, wherein the target video is generated based on a process, and one or more of the at least one programmable circuit is to cause an adjustment of the process based on the quality metric.

Example 13 includes any preceding clause(s) of any one or more of Examples 1-12, wherein one or more of the at least one programmable circuit is to separate the target video into a plurality of target video patches, process the target video patches with the trained neural network to obtain the target features, the target features including subsets of target features corresponding respectively to the plurality of target video patches, separate the reference video into a plurality of reference video patches, and process the reference video patches with the trained neural network to obtain the reference features, the reference features including subsets of reference features corresponding respectively to the plurality of reference video patches, wherein the plurality of target video patches and the plurality of reference video patches have a dimensionality based on an input data size associated with the trained neural network.

Example 14 includes any preceding clause(s) of any one or more of Examples 1-13, wherein the quality metric is an overall quality metric for the target video, and one or more of the at least one programmable circuit is to determine intermediate quality metrics respectively for the target video patches, a first intermediate quality metric for a first target video patch based on the set of weights, a first subset of target features corresponding to the first target video patch, and a first subset of reference features corresponding to a first reference video patch, and determine the overall quality metric based on the intermediate quality metrics.

Example 15 includes at least one non-transitory machine-readable medium comprising instructions to cause at least one programmable circuit to at least obtain, using a trained neural network, target features corresponding to a target video, the target features based on one or more layers of the trained neural network, obtain, using the trained neural network, reference features corresponding to a reference video, the reference features based on the one or more layers of the trained neural network, the reference video associated with the target video, and output a quality metric for the target video based on the target features, the reference features, and a set of weights, the set of weights different from neural network weights included in the trained neural network.

Example 16 includes any preceding clause(s) of Example 15, wherein the one or more layers of the trained neural network include a first layer of the trained neural network, the target features include a subset of target features associated with the first layer, the reference features include a subset of reference features associated with the first layer, and the instructions are to cause one or more of the at least one programmable circuit to compute difference values between ones of the subset of target features and corresponding ones of the subset of reference features along a channel dimension of the first layer, compute distance values based on products of a subset of the weights and the difference values along the channel dimension of the first layer, the subset of the weights corresponding respectively to different channels along the channel dimension of the first layer, average the distance values along temporal and spatial dimensions of the first layer to determine an averaged distance value associated with the first layer, and compute the quality metric based on the averaged distance value.

Example 17 includes any preceding clause(s) of any one or more of Examples 15-16, wherein the quality metric is an overall quality metric for the target video, and the instructions are to cause one or more of the at least one programmable circuit to separate the target video into a plurality of target video patches, process the target video patches with the trained neural network to obtain the target features, the target features including subsets of target features corresponding respectively to the plurality of target video patches, separate the reference video into a plurality of reference video patches, process the reference video patches with the trained neural network to obtain the reference features, the reference features including subsets of reference features corresponding respectively to the plurality of reference video patches, wherein the plurality of target video patches and the plurality of reference video patches have a dimensionality based on an input data size associated with the trained neural network, determine intermediate quality metrics respectively for the target video patches, a first intermediate quality metric for a first target video patch based on the set of weights, a first subset of target features corresponding to the first target video patch, and a first subset of reference features corresponding to a first reference video patch, and determine the overall quality metric based on the intermediate quality metrics.

Example 18 includes a system comprising first circuitry to implement a trained convolutional neural network, instructions, and second circuitry to be programmed based on the instructions to obtain, using a trained convolutional neural network, target features corresponding to a target video, the target features based on one or more layers of the trained convolutional neural network, obtain, using the trained convolutional neural network, reference features corresponding to a reference video, the reference features based on the one or more layers of the trained convolutional neural network, the reference video associated with the target video, and output a quality metric for the target video based on the target features, the reference features, and a set of weights, the set of weights different from neural network weights included in the trained convolutional neural network.

Example 19 includes any preceding clause(s) of Example 18, wherein the one or more layers of the trained convolutional neural network include a first layer of the trained convolutional neural network, the target features include a subset of target features associated with the first layer, the reference features include a subset of reference features associated with the first layer, and one or more of the at least one programmable circuit is to compute difference values between ones of the subset of target features and corresponding ones of the subset of reference features along a channel dimension of the first layer, compute distance values based on products of a subset of the weights and the difference values along the channel dimension of the first layer, the subset of the weights corresponding respectively to different channels along the channel dimension of the first layer, average the distance values along temporal and spatial dimensions of the first layer to determine an averaged distance value associated with the first layer, and compute the quality metric based on the averaged distance value.

Example 20 includes any preceding clause(s) of any one or more of Examples 18-19, wherein the quality metric is an overall quality metric for the target video, and one or more of the at least one programmable circuit is to separate the target video into a plurality of target video patches, process the target video patches with the trained convolutional neural network to obtain the target features, the target features including subsets of target features corresponding respectively to the plurality of target video patches, separate the reference video into a plurality of reference video patches, process the reference video patches with the trained convolutional neural network to obtain the reference features, the reference features including subsets of reference features corresponding respectively to the plurality of reference video patches, wherein the plurality of target video patches and the plurality of reference video patches have a dimensionality based on an input data size associated with the trained convolutional neural network, determine intermediate quality metrics respectively for the target video patches, a first intermediate quality metric for a first target video patch based on the set of weights, a first subset of target features corresponding to the first target video patch, and a first subset of reference features corresponding to a first reference video patch, and determine the overall quality metric based on the intermediate quality metrics.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
instructions; and
at least one programmable circuit to be programmed based on the instructions to:
obtain, using a trained neural network, target features corresponding to a target video, the target features based on one or more layers of the trained neural network;
obtain, using the trained neural network, reference features corresponding to a reference video, the reference features based on the one or more layers of the trained neural network, the reference video associated with the target video; and
output a quality metric for the target video based on the target features, the reference features, and a set of weights.

2. The apparatus of claim 1, wherein one or more of the at least one programmable circuit is to:
obtain, using the trained neural network, sets of target features and sets of reference features associated respectively with a plurality of learning videos; and
determine the set of weights based on the sets of target features, the sets of reference features and a plurality of ground-truth ratings associated respectively with the plurality of learning videos.

3. The apparatus of claim 2, wherein one or more of the at least one programmable circuit is to determine the set of weights based on a correlation between the plurality of ground-truth ratings and a plurality of quality metrics associated respectively with the plurality of learning videos, the plurality of quality metrics based on the sets of target features, the sets of reference features and the set of weights.

4. The apparatus of claim 3, wherein one or more of the at least one programmable circuit is to determine the set of weights to maximize the correlation between the plurality of ground-truth ratings and the plurality of quality metrics.

5. The apparatus of claim 3, wherein the correlation is a Pearson correlation.

6. The apparatus of claim 1, wherein the one or more layers of the trained neural network include a first layer of the trained neural network, the target features include a subset of target features associated with the first layer, the reference features include a subset of reference features associated with the first layer, and one or more of the at least one programmable circuit is to:
compute difference values between ones of the subset of target features and corresponding ones of the subset of reference features along a channel dimension of the first layer;
compute distance values based on products of a subset of the weights and the difference values along the channel dimension of the first layer, the subset of the weights corresponding respectively to different channels along the channel dimension of the first layer; and
compute the quality metric based on the distance values.

7. The apparatus of claim 6, wherein one or more of the at least one programmable circuit is to:
average the distance values along temporal and spatial dimensions of the first layer to determine an averaged distance value associated with the first layer; and
compute the quality metric based on the averaged distance value.

8. The apparatus of claim 7, wherein the average distance value is a first averaged distance value, the one or more layers of the trained neural network includes a plurality of layers of the trained neural network, and one or more of the at least one programmable circuit is to:
compute a plurality of averaged distance values associated respectively with the plurality of layers of the trained neural network, the plurality of averaged distance values including the first averaged distance value, the plurality of layers including the first layer; and
compute the quality metric based on a sum of the plurality of averaged distance values.

9. The apparatus of claim 6, wherein one or more the at least one programmable circuit is to:
interpolate the distance values to determine interpolated distance values having a resolution corresponding to the target video; and
output an error map based on the interpolated distance values.

10. The apparatus of claim 9, wherein one or more the at least one programmable circuit is to perform trilinear interpolation on the distance values to determine the interpolated distance values.

11. The apparatus of claim 1, wherein the set of weights are different from neural network weights included in the trained neural network.

12. The apparatus of claim 1, wherein the target video is generated based on a process, and one or more of the at least one programmable circuit is to cause an adjustment of the process based on the quality metric.

13. The apparatus of claim 1, wherein one or more of the at least one programmable circuit is to:
separate the target video into a plurality of target video patches;
process the target video patches with the trained neural network to obtain the target features, the target features including subsets of target features corresponding respectively to the plurality of target video patches;
separate the reference video into a plurality of reference video patches; and
process the reference video patches with the trained neural network to obtain the reference features, the reference features including subsets of reference features corresponding respectively to the plurality of reference video patches, wherein the plurality of target video patches and the plurality of reference video patches have a dimensionality based on an input data size associated with the trained neural network.

14. The apparatus of claim 13, wherein the quality metric is an overall quality metric for the target video, and one or more of the at least one programmable circuit is to:
determine intermediate quality metrics respectively for the target video patches, a first intermediate quality metric for a first target video patch based on the set of weights, a first subset of target features corresponding to the first target video patch, and a first subset of reference features corresponding to a first reference video patch; and
determine the overall quality metric based on the intermediate quality metrics.

15. At least one non-transitory machine-readable medium comprising instructions to cause at least one programmable circuit to at least:
obtain, using a trained neural network, target features corresponding to a target video, the target features based on one or more layers of the trained neural network;
obtain, using the trained neural network, reference features corresponding to a reference video, the reference features based on the one or more layers of the trained neural network, the reference video associated with the target video; and
output a quality metric for the target video based on the target features, the reference features, and a set of weights, the set of weights different from neural network weights included in the trained neural network.

16. The at least one non-transitory machine-readable medium of claim 15, wherein the one or more layers of the trained neural network include a first layer of the trained neural network, the target features include a subset of target features associated with the first layer, the reference features include a subset of reference features associated with the first layer, and the instructions are to cause one or more of the at least one programmable circuit to:
compute difference values between ones of the subset of target features and corresponding ones of the subset of reference features along a channel dimension of the first layer;
compute distance values based on products of a subset of the weights and the difference values along the channel dimension of the first layer, the subset of the weights corresponding respectively to different channels along the channel dimension of the first layer;
average the distance values along temporal and spatial dimensions of the first layer to determine an averaged distance value associated with the first layer; and
compute the quality metric based on the averaged distance value.

17. The at least one non-transitory machine-readable medium of claim 15, wherein the quality metric is an overall quality metric for the target video, and the instructions are to cause one or more of the at least one programmable circuit to:
separate the target video into a plurality of target video patches;
process the target video patches with the trained neural network to obtain the target features, the target features including subsets of target features corresponding respectively to the plurality of target video patches;
separate the reference video into a plurality of reference video patches;
process the reference video patches with the trained neural network to obtain the reference features, the reference features including subsets of reference features corresponding respectively to the plurality of reference video patches, wherein the plurality of target video patches and the plurality of reference video patches have a dimensionality based on an input data size associated with the trained neural network;
determine intermediate quality metrics respectively for the target video patches, a first intermediate quality metric for a first target video patch based on the set of weights, a first subset of target features corresponding to the first target video patch, and a first subset of reference features corresponding to a first reference video patch; and
determine the overall quality metric based on the intermediate quality metrics.

18. A system comprising
first circuitry to implement a trained convolutional neural network;
instructions; and
second circuitry to be programmed based on the instructions to:
obtain, using a trained convolutional neural network, target features corresponding to a target video, the target features based on one or more layers of the trained convolutional neural network;
obtain, using the trained convolutional neural network, reference features corresponding to a reference video, the reference features based on the one or more layers of the trained convolutional neural network, the reference video associated with the target video; and
output a quality metric for the target video based on the target features, the reference features, and a set of weights, the set of weights different from neural network weights included in the trained convolutional neural network.

19. The system of claim 18, wherein the one or more layers of the trained convolutional neural network include a first layer of the trained convolutional neural network, the target features include a subset of target features associated with the first layer, the reference features include a subset of reference features associated with the first layer, and one or more of the at least one programmable circuit is to:
compute difference values between ones of the subset of target features and corresponding ones of the subset of reference features along a channel dimension of the first layer;
compute distance values based on products of a subset of the weights and the difference values along the channel dimension of the first layer, the subset of the weights corresponding respectively to different channels along the channel dimension of the first layer;
average the distance values along temporal and spatial dimensions of the first layer to determine an averaged distance value associated with the first layer; and
compute the quality metric based on the averaged distance value.

20. The system of claim 18, wherein the quality metric is an overall quality metric for the target video, and one or more of the at least one programmable circuit is to:
separate the target video into a plurality of target video patches;
process the target video patches with the trained convolutional neural network to obtain the target features, the target features including subsets of target features corresponding respectively to the plurality of target video patches;
separate the reference video into a plurality of reference video patches;
process the reference video patches with the trained convolutional neural network to obtain the reference features, the reference features including subsets of reference features corresponding respectively to the plurality of reference video patches, wherein the plurality of target video patches and the plurality of reference video patches have a dimensionality based on an input data size associated with the trained convolutional neural network;
determine intermediate quality metrics respectively for the target video patches, a first intermediate quality metric for a first target video patch based on the set of weights, a first subset of target features corresponding to the first target video patch, and a first subset of reference features corresponding to a first reference video patch; and
determine the overall quality metric based on the intermediate quality metrics.
